(19) United States
(12) Patent Application Publication
(10) Pub. No.: US 2021/0092511 A1
(43) Pub. Date: Mar. 25, 2021

(54) Speaker

(71) Applicant: Yamaha Corporation, Hamamatsu-shi (JP)

(72) Inventor: Masao NORO, Hamamatsu-shi (JP)

(21) Appl. No.: 17/113,954

(22) Filed: Dec. 7, 2020

Related U.S. Application Data
(63) Continuation of application No. PCT/JP2019/021274, filed on May 29, 2019.

(30) Foreign Application Priority Data
Jun. 8, 2018 (JP) 2018-110175

(51) Int. Cl. H04R 1/28; H04R 1/02; H04R 3/04

(52) U.S. Cl. CPC H04R 1/2834; H04R 1/02; H04R 2201/029; H04R 3/04; H04R 1/2815

(57) ABSTRACT

A speaker comprising includes an acoustic generation unit, a tube, and a pressure transmission member. The acoustic generation unit is arranged in a housing and includes a rear surface that faces an inside of the housing. The tube extends from the rear surface to an outside of the housing in a winding manner. The pressure transmission member is arranged at a side wall of the tube. The pressure transmission member is shared by portions of the tube at a plurality of positions that are located at different distances from the rear surface.

### CROSS REFERENCE TO RELATED APPLICATIONS

The present application is a continuation application of International Application No. PCT/JP2019/021274, filed May 29, 2019, which claims a priority to Japanese Patent Application No. 2018-110175, filed Jun. 8, 2018. The contents of these applications are incorporated herein by reference in their entirety.

### TECHNICAL FIELD

The present disclosure relates to a speaker that includes an acoustic tube.

### BACKGROUND

A speaker that includes an acoustic tube within a housing. In this speaker, the acoustic tube surrounds a path (a hollow region) from a rear surface of a speaker unit that is fixed to the housing to the outside of the housing. With this speaker, the bass range of a reproduced sound can be enhanced using resonance of the acoustic tube. However, there is a problem in that in this speaker, high-order resonant waves such as a third-order resonant wave and a fifth-order resonant wave occur in the acoustic tube in addition to a fundamental resonant wave that enhances bass, and a peak and a dip are generated in frequency characteristics of the speaker due to the influence of these high-order resonant waves. Therefore, in a disclosed technology, a damping material that suppresses sound in a frequency range higher than the frequency of the fundamental resonant wave is provided in the acoustic tube.

### SUMMARY

To sufficiently suppress high-order resonant waves in the above-described technology, it is necessary to increase the amount of damping material provided in the acoustic tube. However, if the amount of damping material is increased, there is a problem in that the fundamental resonant wave is suppressed in addition to the high-order resonant waves, and enhancement of bass is hindered in the speaker. Although it is necessary to appropriately select the type and the amount of damping material provided in the acoustic tube to sufficiently suppress the high-order resonant waves without impairing the fundamental resonant wave, it is difficult to select an appropriate type and an appropriate amount of damping material.

The present disclosure was made in view of the above circumstances, and an object of the present disclosure is to provide a technical means for suppressing high-order resonant waves while avoiding suppression of a fundamental resonant wave of an acoustic tube included in a speaker.

One aspect of the present disclosure provides a speaker that includes an acoustic generation unit that is arranged in a housing and includes a rear surface that faces the inside of the housing, a tube that extends from the rear surface to the outside of the housing in a winding manner, and a pressure transmission member that is arranged at a side wall of the tube. The pressure transmission member is shared by portions of the tube at a plurality of positions that are different distances from the rear surface.

Another aspect of the present disclosure provides a speaker that includes an acoustic generation unit that is arranged in a housing, an acoustic tube that surrounds a hollow region that extends from a rear surface of the acoustic generation unit to the outside of the housing, and a pressure transmission member that is sandwiched between hollow regions located at different positions on a path extending in the acoustic tube from the rear surface to the outside. Other objects, advantages and novel features of the present disclosure will become apparent from the following detailed description of one or more preferred embodiments when considered in conjunction with the accompanying drawings, in which:

### BRIEF DESCRIPTION OF THE DRAWINGS

FIGS. 1A to 1C are diagrams showing a principle of suppressing high-order resonant waves in an inventive speaker;

FIG. 2 is a cross-sectional view showing a first specific example of the inventive speaker; and

FIG. 3 is a cross-sectional view showing a second specific example of the inventive speaker.

### DETAILED DESCRIPTION

The following describes an embodiment of the present disclosure with reference to the drawings.

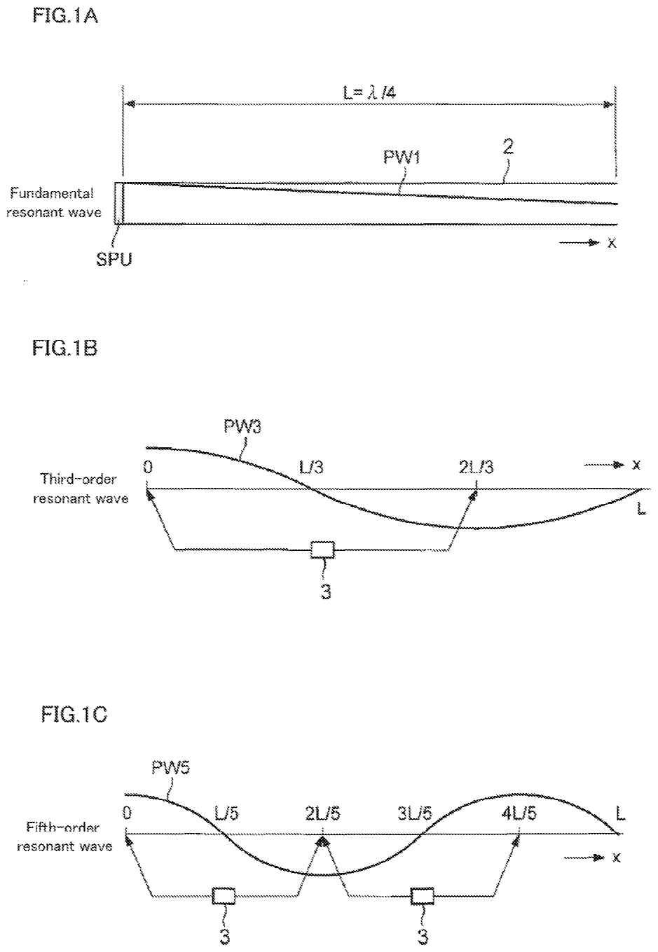

FIGS. 1A to 1C are diagrams showing a principle of suppressing high-order resonant waves in a speaker according to an embodiment of the present disclosure.

The speaker according to the present embodiment includes an acoustic tube for enhancing bass within a housing. The acoustic tube is a tube that surrounds a hollow region that extends in a winding manner from a rear surface of an acoustic reproduction unit that is embedded in a wall surface of the housing of the speaker, specifically a rear surface of a speaker unit SPU, to the outside of the housing. In other words, the acoustic tube defines a path that extends within the housing in a winding manner from the rear surface of the speaker unit SPU to the outside of the housing.

Resonant waves that have wavelengths that correspond to the length of the acoustic tube occur in the acoustic tube. The resonant waves include high-order resonant waves such as a third-order resonant wave and a fifth-order resonant wave in addition to a fundamental resonant wave. The fundamental resonant wave is preferable in terms of enhancing the bass range of sound reproduced by the speaker. However, the high-order resonant waves cause the generation of a peak and a dip in a frequency band higher than the bass range in frequency characteristics of the speaker, and deteriorate the quality of the reproduced sound. Therefore, the present embodiment suppresses the high-order resonant waves that occur in the acoustic tube.

FIG. 1A shows an acoustic tube 2 within the housing. Although an actual acoustic tube that is housed in the housing in the present embodiment is bent at several intermediate positions, FIG. 1A shows the acoustic tube 2 in a straightened state to facilitate understanding of the principle of suppressing the high-order resonant waves.

A fundamental resonant wave PW1 that has the lowest frequency among resonant waves that occur in the acoustic tube 2 has a wavelength λ that is four times a tube length L of the acoustic tube 2. That is, the wavelength λ of the fundamental resonant wave PW1 is 4L. Note that in the following description, the fundamental resonant wave PW1, a third-order resonant wave PW3, and a fifth-order resonant wave PW5 refer to pressure components in the fundamental resonant wave and the high-order resonant waves.

When x represents the distance from the rear surface of the speaker unit SPU within the acoustic tube 2, as shown in FIG. 1A, an anti-node of the fundamental resonant wave PW1 occurs at x=0, i.e., the position of the rear surface of the speaker unit SPU, and a node of the fundamental resonant wave PW1 occurs at x=L, i.e., on an exit side of the housing.

FIG. 1B shows the third-order resonant wave PW3 that occurs in the acoustic tube 2 and FIG. 1C shows the fifth-order resonant wave PW5 that occurs in the acoustic tube 2.

As shown in FIG. 1B, in the acoustic tube 2, an anti-node of the third-order resonant wave PW3 occurs at the position where x=0, a node of the third-order resonant wave PW3 occurs at a position where x=L/3, an anti-node of the third-order resonant wave PW3 occurs at a position where x=2L/3, and a node of the third-order resonant wave PW3 occurs at the position where x=L. Here, the anti-node of the third-order resonant wave PW3 occurring at the position where x=0 and the anti-node of the third-order resonant wave PW3 occurring at the position where x=2L/3 are opposite to each other in phase.

Also, as shown in FIG. 1C, in the acoustic tube 2, an anti-node of the fifth-order resonant wave PW5 occurs at the position where x=0, a node of the fifth-order resonant wave PW5 occurs at a position where x=L/5, an anti-node of the fifth-order resonant wave PWS occurs at a position where x=2L/5, a node of the fifth-order resonant wave PW5 occurs at a position where x=3L/5, an anti-node of the fifth-order resonant wave PW5 occurs at a position where x=4L/5, and a node of the fifth-order resonant wave PW5 occurs at the position where x=L. Here, the anti-node of the fifth-order resonant wave PW5 occurring at the position where x=0 and the anti-node of the fifth-order resonant wave PW5 occurring at the position where x=2L/5 are opposite to each other in phase. Also, the anti-node of the fifth-order resonant wave PW5 occurring at the position where x=2L/5 and the anti-node of the fifth-order resonant wave PW5 occurring at the position where x=4L/5 are opposite to each other in phase.

Therefore, in the present embodiment, the acoustic tube 2 extends in a winding manner within the housing 1 such that different portions on the path defined by the acoustic tube 2 share a side wall to suppress the high-order resonant waves. Also, in the acoustic tube 2, a pressure transmission member 3 is arranged in a portion of the side wall shared by the different portions on the path. Accordingly, the pressure transmission member 3 is shared by portions of the acoustic tube 2 at a plurality of positions that are different distances from the rear surface of the speaker unit SPU.

More specifically, to suppress the third-order resonant wave PW3, the acoustic tube 2 is bent such that a wall of the acoustic tube 2 surrounding a region near the position where x=0 and a wall of the acoustic tube 2 surrounding a region near the position where x=2L/3 are in contact with each other. Also, an opening is provided in a wall that is sandwiched between the region near the position where x=0 and the region near the position where x=2L/3. Furthermore, the pressure transmission member 3 that is sandwiched between these regions is provided in the opening. In a preferable aspect, the pressure transmission member 3 is a diaphragm having a resonance frequency that is the same as the frequency of the third-order resonant wave. A passive radiator is preferably used as the diaphragm. The passive radiator has a configuration that is obtained by removing an electromagnetic circuit from a speaker unit and is usually used as a speaker unit that operates using vibration of air within a speaker housing. In the present embodiment, the passive radiator is used as a means for transmitting a pressure wave within the acoustic tube.

With this configuration, vibration of the anti-node of the third-order resonant wave PW3 occurring at the position where x=2L/3 is transmitted via the pressure transmission member 3 to the position where x=0. Here, the anti-node of the third-order resonant wave PW3 occurring at the position where x=0 and the anti-node of the third-order resonant wave PW3 occurring at the position where x=2L/3 are opposite to each other in phase. Therefore, the anti-nodes of the third-order resonant wave PW3 occurring at the position where x=0 and the position where x=2L/3 cancel each other out in a vibration transmission path connecting these positions. As a result, the third-order resonant wave PW3 is suppressed.

To suppress the fifth-order resonant wave PW5, the acoustic tube 2 is bent such that a wall of the acoustic tube 2 surrounding a region near the position where x=0 and a wall of the acoustic tube 2 surrounding a region near the position where x=2L/5 are in contact with each other. Also, an opening is provided in a wall that is sandwiched between the region near the position where x=0 and the region near the position where x=2L/5. Furthermore, a pressure transmission member 3 that is sandwiched between these regions, preferably a diaphragm having a resonance frequency that is the same as the frequency of the fifth-order resonant wave, is provided in the opening. With this configuration, the fifth-order resonant wave PW5 is suppressed similarly to the third-order resonant wave PW3.

Alternatively, the acoustic tube 2 is bent such that a wall of the acoustic tube 2 surrounding a region near the position where x=2L/5 and a wall of the acoustic tube 2 surrounding a region near the position where x=4L/5 are in contact with each other. Also, an opening is provided in a wall that is sandwiched between the region near the position where x=2L/5 and the region near the position where x=4L/5. Furthermore, a diaphragm can also be provided in the opening. In this case as well, the fifth-order resonant wave PW5 can be similarly suppressed.

Although the principle of suppressing high-order resonant waves in the present embodiment has been described using the third-order resonant wave PW3 and the fifth-order resonant wave PW5 as examples, another high-order resonant wave can also be attenuated in the present embodiment.

The present embodiment can be generalized as follows. In the present embodiment, when L represents the entire length of the acoustic tube 2, M represents an odd number greater than 2, N1 represents an even number greater than or equal to 0 and smaller than M, and N2 represents a number greater than N1 by 2 and smaller than M, in the acoustic tube 2, the pressure transmission member 3 is sandwiched between a hollow region that is located at a distance of approximately N1·L/M from the rear surface of the speaker unit SPU and a hollow region that is located at a distance of approximately N2·L/M from the rear surface. Or when L represents the entire length of the acoustic tube 2, M=3+2m, N1=2n₁, N2=N1+2+4n₂, N1<M, and N2<M (m, n₁, and n₂ are all integers greater than or equal to 0), in the acoustic tube 2, the pressure transmission member 3 is sandwiched between a hollow region that is located at a distance of approximately N1·L/M from the rear surface of the speaker unit SPU and a hollow region that is located at a distance of approximately N2·L/M from the rear surface. Also, a diaphragm that has the same resonance frequency as a resonance frequency that is determined by a length obtained by dividing L by M (a frequency of a resonant wave having a wavelength of 4L/M) is used as the pressure transmission member 3. Thus, it is possible to suppress a high-order resonant wave that has a frequency determined by the length obtained by dividing L by M (a resonant wave having a wavelength of 4L/M).

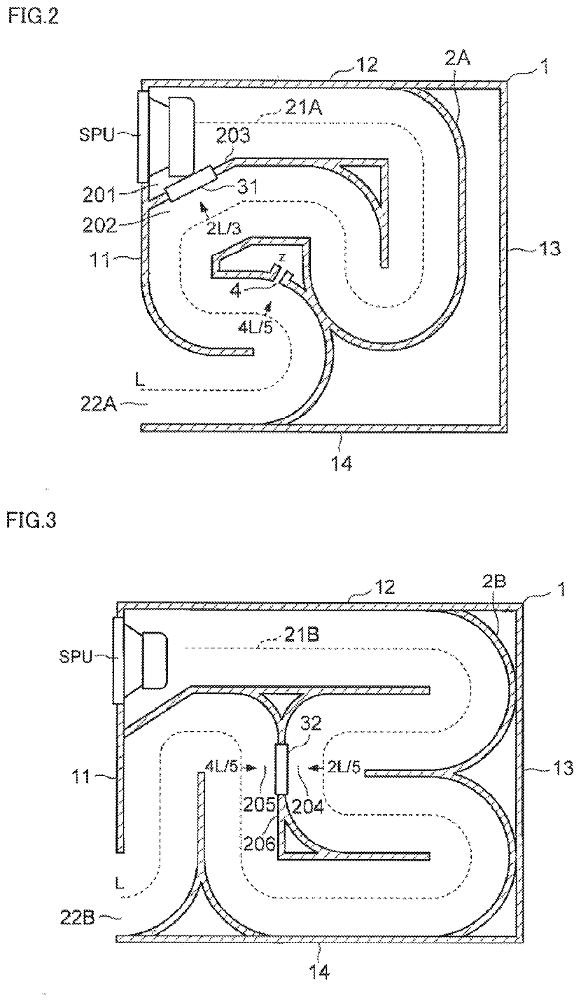

FIG. 2 is a cross-sectional view showing a first specific example of the speaker according to the present embodiment. FIG. 2 shows four walls 11 to 14 out of six walls that constitute a rectangular parallelepiped housing 1. A speaker unit SPU, which is an acoustic generation unit, is inserted in and fixed to an opening that is formed in the wall 11. Also, the wall 11 includes an exit 22A. The wall 13 faces the wall 11. The walls 12 and 14 sandwich a space between the walls 11 and 13 from both sides in the up-down direction in FIG. 2.

An acoustic tube 2A is housed in the housing 1 in a winding state and surrounds a hollow space that extends from a rear surface of the speaker unit SPU to the exit 22A. The acoustic tube 2A can have a circular cross section, a rectangular cross section, or another shape. A tube axis 21A of the acoustic tube 2A is shown by a dashed line in FIG. 2.

When L represents the length of the acoustic tube 2A along the tube axis 21A from the rear surface of the speaker unit SPU to the exit 22A of the housing 1 in FIG. 2, the length L is ¼ of a wavelength λ of a fundamental resonant wave that is generated in the acoustic tube 2A to enhance bass.

In the specific example shown in FIG. 2, the acoustic tube 2A extends from a region of the wall 11 to which the speaker unit SPU is fixed toward the wall 13 (this section will be referred to as a “first section”), turns in front of the wall 13 to extend along the wall 13 toward the wall 14, turns back in front of the wall 14 to extend toward the wall 12, reaches the first section of the acoustic tube 2A, and then extends adjacently to the first section toward the wall 11. With this configuration, in the first specific example, a first hollow region 201 within the acoustic tube 2A near the rear surface of the speaker unit SPU and a second hollow region 202 within the acoustic tube 2A near a position located at a distance of 2L/3 from the rear surface of the speaker unit SPU are adjacent to each other with a wall 203 of the acoustic tube 2A sandwiched therebetween.

In this specific example, the wall 203 includes an opening through which the first hollow region 201 and the second hollow region 202 are in communication, and a passive radiator 31 is inserted in and fixed to this opening. The passive radiator 31 only transmits pressure between the first hollow region 201 and the second hollow region 202, without letting air flow in or out between the regions. The passive radiator 31 is a diaphragm having a resonance frequency that is the same as the frequency of a third-order resonant wave that occurs in the acoustic tube 2A.

If the third-order resonant wave occurs in the acoustic tube 2A, an anti-node of the third-order resonant wave occurs in the first hollow region 201 within the acoustic tube 2A, and an anti-node that is opposite in phase to the anti-node occurring in the first hollow region 201 occurs in the second hollow region 202 (see FIG. 1B). A pressure wave of the anti-node in the opposite phase occurring in the second hollow region 202 is transmitted to the first hollow region 201 via the passive radiator 31. As a result, the anti-node of the third-order resonant wave and the anti-node in the opposite phase cancel each other out and the third-order resonant wave is suppressed.

Furthermore, in this specific example, a Helmholtz resonator 4 is provided in an inner wall of the acoustic tube 2A that is located at a distance of 4L/5 from the rear surface of the speaker unit SPU. Here, if a fifth-order resonant wave occurs in the acoustic tube 2A, an anti-node of the fifth-order resonant wave occurs at a position in the acoustic tube 2A located at the distance of 4L/5 from the rear surface of the speaker unit SPU. The Helmholtz resonator 4 used in this specific example has a resonance frequency that is the same as the frequency of the fifth-order resonant wave. Similarly to a known Helmholtz resonator, the Helmholtz resonator 4 is constituted by a tube and a cavity, and the resonance frequency is determined by the length and the cross-sectional area of the tube, the volume of the cavity, and the like. Therefore, in the first specific example, the length and the cross-sectional area of the tube, the volume of the cavity, and the like are determined such that the resonance frequency of the Helmholtz resonator 4 is equal to the frequency of the fifth-order resonant wave to suppress the fifth-order resonant wave.

FIG. 3 is a cross-sectional view showing a second specific example of the speaker according to the present embodiment. FIG. 3 shows the housing 1 and the walls 11 to 14 constituting the housing 1, which are like those shown in FIG. 2. The speaker unit SPU and an exit 22B are provided in the wall 11.

An acoustic tube 2B is housed in the housing 1 in a winding state and surrounds a hollow space that extends from the rear surface of the speaker unit SPU to the exit 22B.

Like FIG. 2, when L represents the length of a tube axis 21B of the acoustic tube 2B from the rear surface of the speaker unit SPU to the exit 22B of the housing 1, the length L is ¼ of a wavelength λ of a fundamental resonant wave that is generated in the acoustic tube 2B to enhance bass.

In the specific example shown in FIG. 3, the acoustic tube 2B extends along the wall 12 from a region of the wall 11 to which the speaker unit SPU is fixed toward the wall 13, turns back at the wall 13 toward the wall 11, turns back approximately at the center of the housing 1 toward the wall 13, turns back at the wall 13 toward the wall 11 to extend along the wall 14, and turns in front of the wall 11 to extend toward the wall 12. With this configuration, in the second specific example, a third hollow region 204 within the acoustic tube 2B near a position located at a distance of 2L/5 from the rear surface of the speaker unit SPU and a fourth hollow region 205 within the acoustic tube 2B near a position located at a distance of 4L/5 from the rear surface of the speaker unit SPU are adjacent to each other with a wall 206 sandwiched therebetween.

In this specific example, the wall 206 includes an opening through which the third hollow region 204 and the fourth hollow region 205 are in communication, and a passive radiator 32 is inserted in and fixed to the opening. The passive radiator 32 is a diaphragm having a resonance frequency that is the same as the frequency of a fifth-order resonant wave that occurs in the acoustic tube 2B.

If the fifth-order resonant wave occurs in the acoustic tube 2B, an anti-node of the fifth-order resonant wave occurs in the third hollow region 204 within the acoustic tube 2B, and an anti-node that is opposite in phase to the anti-node occurring in the third hollow region 204 occurs in the fourth hollow region 205 (see FIG. 1C) . A pressure wave of the anti-node in the opposite phase occurring in the fourth hollow region 205 is transmitted to the third hollow region 204 via the passive radiator 32. As a result, the anti-node of the fifth-order resonant wave and the anti-node in the opposite phase cancel each other out and the fifth-order resonant wave is suppressed.

As described above, according to the present embodiment, it is possible to suppress a high-order resonant wave by transmitting pressure between positions at which the high-order resonant wave occurring in the acoustic tube has substantially opposite phases. Here, the positions at which the phases are substantially opposite include a certain margin of error, rather than including only positions at which the phases are exactly opposite, and these positions refer to positions at which an effect of suppressing the amplitude of the high-order resonant wave can be achieved as a result of pressure being transmitted. In particular, the high-order resonant wave can be more efficiently suppressed if pressure is transmitted between an anti-node of the high-order resonant wave occurring in the acoustic tube and an anti-node in the opposite phase. Therefore, according to the present embodiment, the high-order resonant wave can be suppressed in the acoustic tube of the speaker without the generation of the fundamental resonant wave being hindered.

Although one embodiment of the present disclosure has been described, other embodiments of the present disclosure are also possible. The followings are examples.

(1) In FIG. 2, portions of the tube axis 21A can be in the same plane, but a configuration is also possible in which the positions of the portions change in the direction perpendicular to the sheet face of FIG. 2. This also applies to FIG. 3.

(2) A configuration is also possible in which both the passive radiator 31 shown in FIG. 2 and the passive radiator 32 shown in FIG. 3 are provided in an acoustic tube.

(3) Although a passive radiator can be preferably used as the pressure transmission member as in the above-described embodiment, this is not a limitation, and a member that can efficiently transmit pressure can be appropriately selected. The foregoing disclosure has been set forth merely to illustrate the embodiments of invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A speaker comprising:
an acoustic generation unit that is arranged in a housing and includes a rear surface that faces an inside of the housing;
a tube that extends from the rear surface to an outside of the housing in a winding manner; and
a pressure transmission member that is arranged at a side wall of the tube, wherein
the pressure transmission member is shared by portions of the tube at a plurality of positions that are located at different distances from the rear surface.

2. The speaker according to claim 1, wherein the plurality of positions at which the pressure transmission member is shared are positions at which a third or higher-order resonant wave that occurs in the tube has substantially opposite phases.

3. The speaker according to claim 2, wherein when L represents an entire length of the tube, M=3+2m, N1=2n₁, N2=N1+2+4n₂, N1<M, and N2<M (where m, n₁, and n₂ are all integers greater than or equal to 0), the plurality of different positions at which the pressure transmission member is shared are located at a distance of N1·L/M from the rear surface and a position located at a distance of N2·L/M from the rear surface.

4. The speaker according to claim 3, wherein the pressure transmission member is a diaphragm that has a same resonance frequency as a resonance frequency that is determined by a length obtained by dividing L by M.

5. The speaker according to claim 4, wherein
the plurality of different positions at which the pressure transmission member is shared are near the rear surface and at a distance of ⅔ of the entire length of the tube from the rear surface, and
a resonance frequency of the diaphragm is a frequency according to which a wavelength of vibration is 4/3 times the entire length of the tube.
